(19) United States
(12) Patent Application Publication
(10) Pub. No.: US 2011/0243152 A1
(43) Pub. Date: Oct. 6, 2011

(54) MODULAR SYSTEM, APPARATUS AND METHOD FOR PROVIDING A NETWORK CONNECTION

(75) Inventors: Jose Goncalves, North Vancouver (CA); Bradley George Kelly, Port Moody (CA); Mohammad Tootoonian, Vancouver (CA)

(73) Assignee: NYCE NETWORKS INC., Burnaby, BC (CA)

(21) Appl. No.: 13/055,137

(22) PCT Filed: Jul. 22, 2009
(86) PCT No.: PCT/CA2009/001044

§ 371 Date: Jun. 20, 2011

Related U.S. Application Data
(60) Provisional application No. 61/082,769, filed on Jul. 22, 2008.

(51) Int. Cl. H04L 12/66

(52) U.S. Cl. 370/463

(57) ABSTRACT

Described herein are a network access module, system, and method for allowing a user to access a network. The network access module includes a network interface device and a modular outlet device. The network interface device includes a network access port assembly communicatively connectable with the network, and a first interface connector communicatively connected to the first network access port. The modular outlet device includes a network access jack configured to accept a plug of a network communication cable, and a second interface connector communicatively connected to the jack. The network interface and modular outlet devices each have a releasable coupling that is configured to physically couple the network interface and modular outlet devices together such that the first and second interface connectors are communicatively connected to each other. A variety of different modular outlet devices can be coupled to the network interface device, thereby resulting in a network access module that can be easily configured to exhibit different types of functionality.

### FIELD OF THE INVENTION

The present invention relates to a modular system, apparatus and method for providing a network connection.

### BACKGROUND OF THE INVENTION

Increasingly, consumers are relying on packet switched networks for the delivery of content. An ubiquitous example of such reliance is the delivery of a myriad of different types of content via the Internet. In order to facilitate the delivery of content via the Internet, it is common for consumers to have high-speed, or broadband, Internet connections. These connections often take the form of a cable or digital subscriber line modem/router that acts as a bridge between a wide area network (“WAN”), such as the Internet, and a consumer's own local area network (“LAN”). While these broadband connections provide much greater bandwidth than older connections available over a traditional public switched telephone network, even with such a broadband connection obtaining the high QOS network access required for high bandwidth content can be problematic.

Content in the form of video is one type of high bandwidth content that is very sensitive to the network limitations inherent in most broadband Internet connections used today. This video content can take the form of both video content transmitted over the Internet, and Internet Protocol Television (“IPTV”), which transmits video content over private networks distinct from the Internet. In both cases, a delay in transmitting packets can result in signal degradation in the form of pixelization or, at worst, a blank video screen, both of which being unacceptable to consumers. Such signal degradation can be remedied by increasing the bandwidth available to the consumer.

One problem currently faced in increasing bandwidth is providing a suitable “last mile” network infrastructure. The “last mile” refers to the final leg of delivering connectivity from a communications provider to a consumer, and includes the wiring that provides connectivity within residences such as houses or apartment buildings, for example.

Wiring that relies on electrical signals to convey content through the last mile, such as standard category 5, 5e, and 6 cables (“Ethernet cables”) used in traditional Ethernet applications, can be susceptible to noise or interference that results in signal degradation. Such noise or interference is generally non-periodic, cross-coupled “spiky” or “transient” interference (hereinafter collectively referred to as “transients”) caused by using certain twisted pairs within the Ethernet cables for traditional telephony signals (such as category 3 cable), which signals are inductively coupled to and consequently cause transients in the twisted pairs used for Ethernet signals. Transients are also caused by running the category 515e/6 cable in close proximity to alternating current (“AC”) power lines within the house or apartment building, which lines are also inductively coupled to and consequently cause transients in the Ethernet cables. In either case, the result of such transients is that the common-mode rejection benefits associated with Ethernet cables that result from their shielding and use of differential signalling are overwhelmed by the transients, and the transmission of Ethernet signals is noticeably impeded.

In order to compensate for transients, telecommunication companies are forced to install multiple, shielded runs of cable within a building using multiple conduits spaced significantly from cables carrying AC power or traditional telephony signals, which dramatically increases installation costs. An additional drawback to this method of installation is that not all Ethernet jacks available to the consumer within the building will be capable of supplying a high QOS network connection, and consequently a builder or contractor has to pre-select which Ethernet jacks within the building are going to be connected to cables that are capable of providing a consistently high QOS network connection, and which Ethernet jacks are not. Thus, in addition to increasing installation complexity and costs, this method of installation can result in a system that is cumbersome for the consumer to use.

Using glass optical fiber to convey content overcomes the problems caused by transients, but the equipment designed for use with glass optical fiber is generally designed for server-side industrial networking applications and is prohibitively expensive for residential and many typical commercial applications. Furthermore, glass optical fiber is a very difficult medium with which to work, further increasing installation costs.

Additionally, within almost all buildings, there exists traditional voice telephony systems wired using category 3 cable. Such telephone systems typically terminate in a RJ-11 (6P6C) jack that is housed within a wall, into which a consumer can plug a conventional telephone. As such RJ-11 (6P6C) jacks are well known to telecommunications utilities and their technicians, it would be advantageous if a system for providing a network connection with a high QOS could be implemented in conjunction with existing voice telephony technology. Such a system for providing a high QOS network connection would be easier for a telecommunications utility to implement than a standalone system, as the system would utilize, at least in part, technology with which the telecommunications utility is already familiar.

Further, both the telecommunications utility and the end consumer would benefit from such a system that would be modular in nature, allowing the end consumer to dynamically reconfigure their home or business network as their connectivity needs changed. This would benefit the telecommunications industry directly, allowing for the provisioning of network connectivity at all possible network connection points with the home or business, without having to absorb the cost of providing complete connectivity upon initial installation. Of additional benefit to the telecommunications utility is the reduction in “truck rolls” of technicians to homes or businesses by off-loading future network re-configuration or expansion to the end consumer, creating a simpler and more cost effective business model of network component sales without installation overhead costs.

Consequently, there is a need for a modular system that can provide network connection with a high QOS to a consumer that improves on at least one of the above-noted deficiencies of the prior art.

### SUMMARY OF THE INVENTION

Accordingly, it is an object of the invention to provide at least one of a modular system, apparatus or method that can provide a network connection to a consumer that improves on at least one of the deficiencies of the prior art.

According to first aspect, there is provided a network access module for allowing a user to access a network. The modules includes a network interface device and a modular outlet device. The network interface device includes a network access port assembly communicatively connectable with the network; and a first interface connector communicatively connected to the first network access port. The modular outlet device includes a network access jack configured to accept a plug of a network communication cable; and a second interface connector communicatively connected to the jack. The network interface and modular outlet devices each have a releasable coupling configured to physically couple the network interface and modular outlet devices together such that the first and second interface connectors are communicatively connected to each other.

The first network access port assembly can be configured to receive power from the network. When so configured, the network interface device also includes power supply circuitry electrically connected to the first network access port to receive power therefrom.

The modular outlet device can also have power consuming circuitry. The first interface connector can have a power contact that is electrically coupled to the power supply circuitry and the second interface connector can have a power contact that is electrically coupled to the power consuming circuitry within the modular outlet device. The power contacts of the first and second interface connectors can be positioned to contact each other when the modular outlet device is physically coupled to the network access module by the releasable couplings such that the modular outlet device is powered when physically coupled to the network interface device.

The network access port assembly can also include a telephonic network access block connectable to a telephone cable and configured to allow access to a telephonic network. The telephone cable can have power carrying wires that supply power to the power supply circuitry via the telephone cable when the telephone cable is connected to the telephonic network access block.

The network access port assembly can also have a network-side Ethernet jack that is configured to accept a network-side Ethernet plug carrying an electrical signal, thereby allowing access to an Ethernet network.

The network access jack can include a user-side Ethernet jack and/or a telephone jack. The first interface connector can be communicatively connected to the network-side Ethernet jack and to the telephonic network access block, and the second interface connector can be communicatively connected to the user-side Ethernet jack and the telephone jack, and the first and second interface connectors can be configured so that when connected to each other the network-side and user-side Ethernet jacks are in communication, and the telephonic network access block and the telephone jack are in communication.

The modular outlet device can also include an Ethernet switch communicatively coupled between the second interface connector and the user-side Ethernet jack, thereby facilitating transmission of Ethernet signals.

The network access port assembly can also include an optical-electrical transceiver that is configured to receive an optical fiber from an optical Ethernet network and to allow access to the optical Ethernet network by enabling bi-directional conversion between optical and electrical network signals.

The network access jack can include a user-side Ethernet jack and a telephone jack. The first interface connector can be communicatively connected to the network-side Ethernet jack and to the telephonic network access block, and the second interface connector can be communicatively connected to the user-side Ethernet jack and the telephone jack, with the first and second interface connectors configured so that when connected to each other the network-side and user-side Ethernet jacks are in communication, and the telephonic network access block and telephone jack are in communication.

The modular outlet device can include an Ethernet switch communicatively coupled between the second interface connector and the user-side Ethernet jack, thereby facilitating transmission of Ethernet signals.

According to a further aspect, there is provided a system for allowing a user to access a network. The system can include a router in electrical communication with the network, and a first network access module, as described above, that is communicatively coupled with the router via the network access port assembly.

The system can also include a telephonic hub in electrical communication with a telephonic network, and a telephone cable. The network access port of the first network access module can be communicatively coupled to the telephonic hub via the telephone cable.

The system can further include a power supply in electrical communication with the telephonic hub. The telephone cable can have a pair of power carrying wires in electrical communication with the power supply.

Additionally, the system may include a bi-directional media converter disposed between the router and the first network access module and configured to bi-directionally convert between electrical and optical signals. The bi-directional media converter can be in electrical communication with the router and in optical communication with the optical-electrical transceiver of the first network access module.

The bi-directional media converter can include a second network access module having an optical-electrical transceiver. The network access port of the second network access module can be electrically coupled to the router, and the optical-electrical transceiver of the second network access module can be optically coupled to the optical-electrical transceiver of the first network access module.

The second network access module can be disposed between the power supply and the telephonic hub, and the system can further include a second telephone cable having a pair of power carrying wires. The power supply can be electrically coupled to the telephone jack of the second network access module and the telephone hub can be electrically coupled to the telephonic network access block of the second network access module. In this configuration, the power supply thereby supplies power to the telephonic hub.

According to a further aspect, there is provided a method for allowing a user to access a network. The method includes receiving a signal from the network, and using a router to route the signal to a network access module as claimed in any one of claims 1 to 10, the network access module communicatively coupled with the router. The signal received from the network may be an electrical signal, and the electrical signal may be converted into an optical signal that is then routed to the network access module.

Beneficially, the use of the modular outlet devices allows the network access module to be easily configured to suit a variety of situations. For example, depending on the type of modular outlet device that is coupled to the network interface device, the network access module can be configured to support, for example, wireless, telephone, and electrical Ethernet communications.

Furthermore, in those aspects wherein power can be supplied to the network access module via the telephonic network access block and/or the telephone jack on the modular outlet device, power can be supplied to a network access module remotely located from the telephonic hub and then conducted to the telephonic hub via telephone cable. From the telephonic hub, the power can then be conducted to other network access modules. Such functionality is especially beneficial when retrofitting existing buildings to have enhanced network connectivity, as many existing buildings are not designed to allow a power supply to be located near the telephonic hub in the building; consequently, by supplying power via the network access module that is remotely located from the telephonic hub, the power supply can also be located remotely from the telephonic hub, yet still be used to supply power to other network access modules via the telephonic hub.

### BRIEF DESCRIPTION OF THE DRAWINGS

In the accompanying drawings, which illustrate exemplary embodiments of the present invention:

FIG. 1 is a schematic of a system capable of providing a high QOS network connection to a consumer, according to one embodiment of the present invention, wherein a single multi-port bi-directional media converter is used to provide connectivity to multiple remote bi-directional media converter devices while allowing a consumer to access a traditional telephony system.

FIG. 2 is a block diagram of the multi-port bi-directional media converter that composes part of the system as depicted in FIG. 1.

FIGS. 3(a) and 3(b) are perspective views of the multi-port bi-directional media converter as depicted in FIG. 2.

FIGS. 3(c) and 3(d) are perspective views of the multi-port bi-directional media converter capable of wireless connectivity, according to an alternative embodiment.

FIG. 4 is a block diagram of a 2-port plastic optical fiber (“POF”) network interface device that composes part of the bi-directional media converter devices used in the system depicted in FIG. 1.

FIG. 5 illustrates front and back views of the 2-port POF network interface device as depicted in FIG. 4.

FIG. 6 is a block diagram of a 2-port modular outlet device that composes part of the bi-directional media converter devices used in the system depicted in FIG. 1.

FIG. 7 illustrates front and back exploded views of the 2-port modular outlet device as depicted in FIG. 6.

FIG. 8 is a block diagram of a 2-port modular outlet device with wireless capability that composes part of the bi-directional media converter devices used in the system depicted in FIG. 1.

FIG. 9 illustrates front and back exploded views of the 2-port modular outlet device with wireless capability as depicted in FIG. 8.

FIG. 10 is a block diagram of a 4-port modular outlet device that composes part of the bi-directional media converter devices used in the system depicted in FIG. 1.

FIG. 11 illustrates front and back exploded views of the 4-port modular outlet device as depicted in FIG. 10.

FIG. 12 is a block diagram of a 2-port telephony-only modular outlet device that composes part of the bi-directional media converter devices used in the system depicted in FIG. 1.

FIG. 13 illustrates front and back views of the 2-port telephony-only modular outlet device as depicted in FIG. 12.

FIG. 14 is a schematic of a system capable of providing a network connection to a consumer, according to a further embodiment of the present invention, wherein the system network cabling makes use of pre-existing category 5/5e/6 electrical cable while allowing a consumer to access a traditional telephonic network.

FIG. 15 is a block diagram of a 2-port Ethernet network interface device that composes part of the bi-directional media converter devices used in the system depicted in FIG. 1.

FIG. 16 contains perspective views of the 2-port Ethernet network interface device as depicted in FIG. 15.

FIG. 17 is a schematic of a system capable of providing a high QOS network connection to a consumer, according to a further embodiment of the present invention, wherein the outside network services to the residence or business do not share a single installation access point within the residence or business, nor is there a convenient electrical power source near the telephony installation point, so multiple remote bi-directional media converter devices are used to provide connectivity while allowing a consumer to access a traditional telephonic network.

### DETAILED DESCRIPTION OF AN EXEMPLARY EMBODIMENT

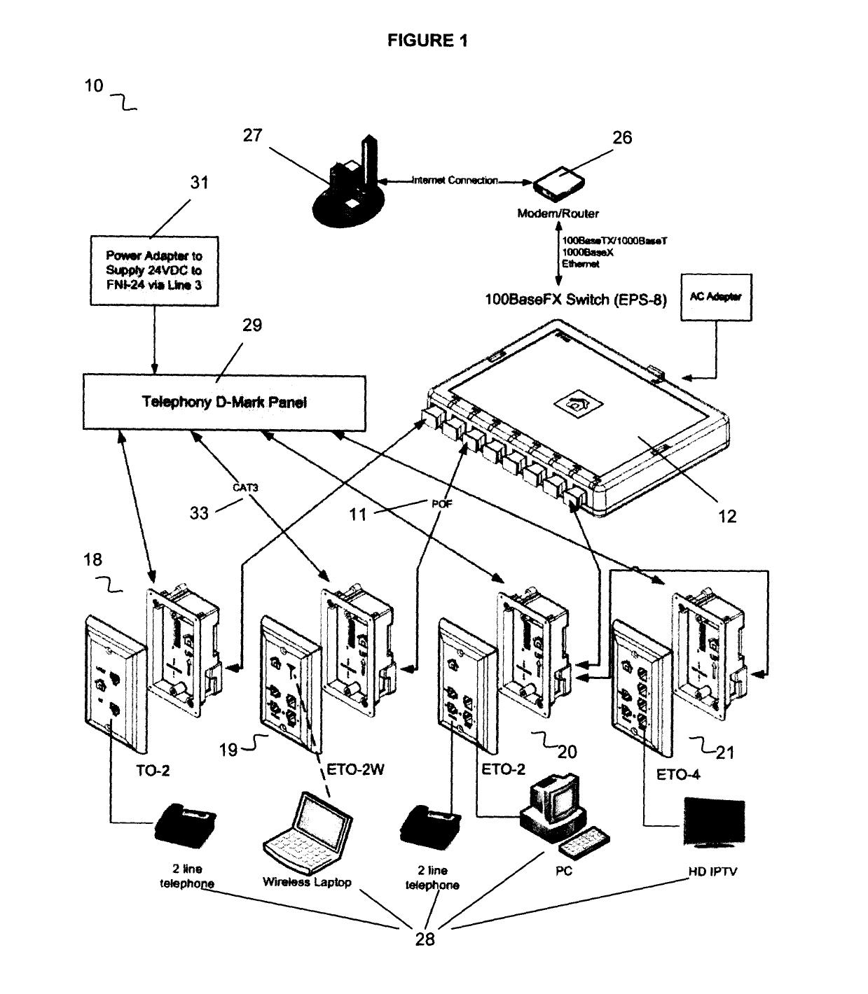

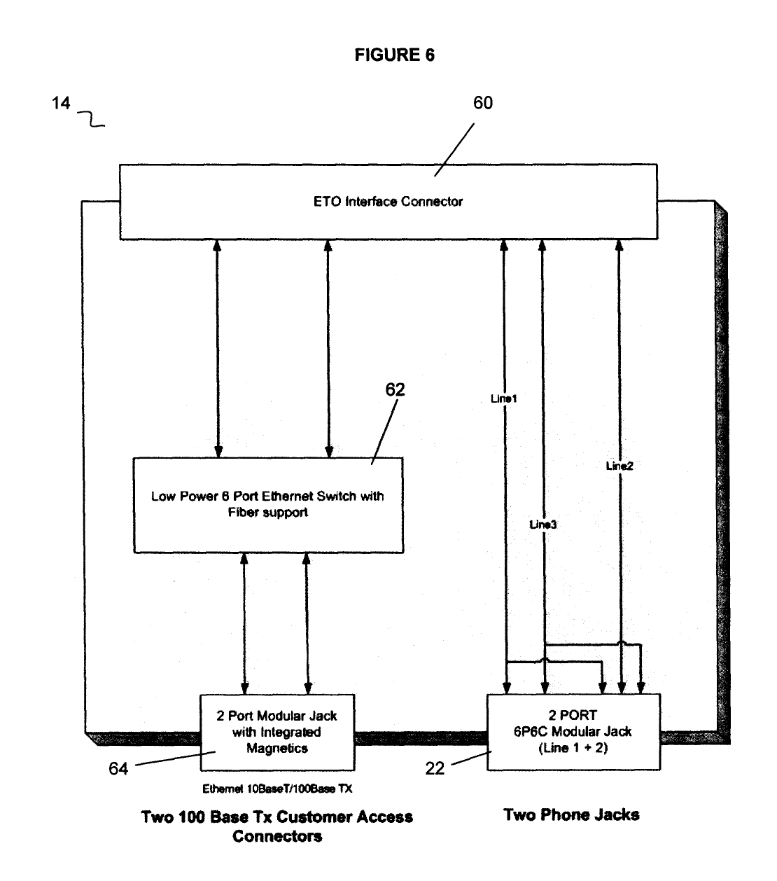

Referring first to FIG. 1, there is depicted an embodiment of a network 10 that uses POF 11 to deliver content to consumers. In the embodiment as depicted, the network 10 has network access modules in the form of bi-directional media converter devices 18, 19, 20, 21, each having a 2-port POF network interface device 13 combined with one of several modular outlet devices 14, 15, 16, 17, that allow a consumer to access the network 10 using one or both of a typical Ethernet cable or a wireless connection. In this application, “modular” means that any of several modular outlet devices 14, 15, 16, 17 can be releasably coupled to the network interface device 13, which enables a variety of media converter devices 18, 19, 20, 21 to be created, each of which has different functionality. Any type of suitable releasable coupling can be used; for example, screws or a latch can be used to releasably couple the modular outlet devices 14, 15, 16, 17 to the network interface device 13. The media converter devices 18, 19, 20, 21 used in the embodiment of the network 10 as depicted in FIG. 1 also allow a consumer to access a traditional telephony system via telephone jacks 22, 23, 24, 25 (not labelled in FIG. 1, but labelled in FIGS. 6 through 13).

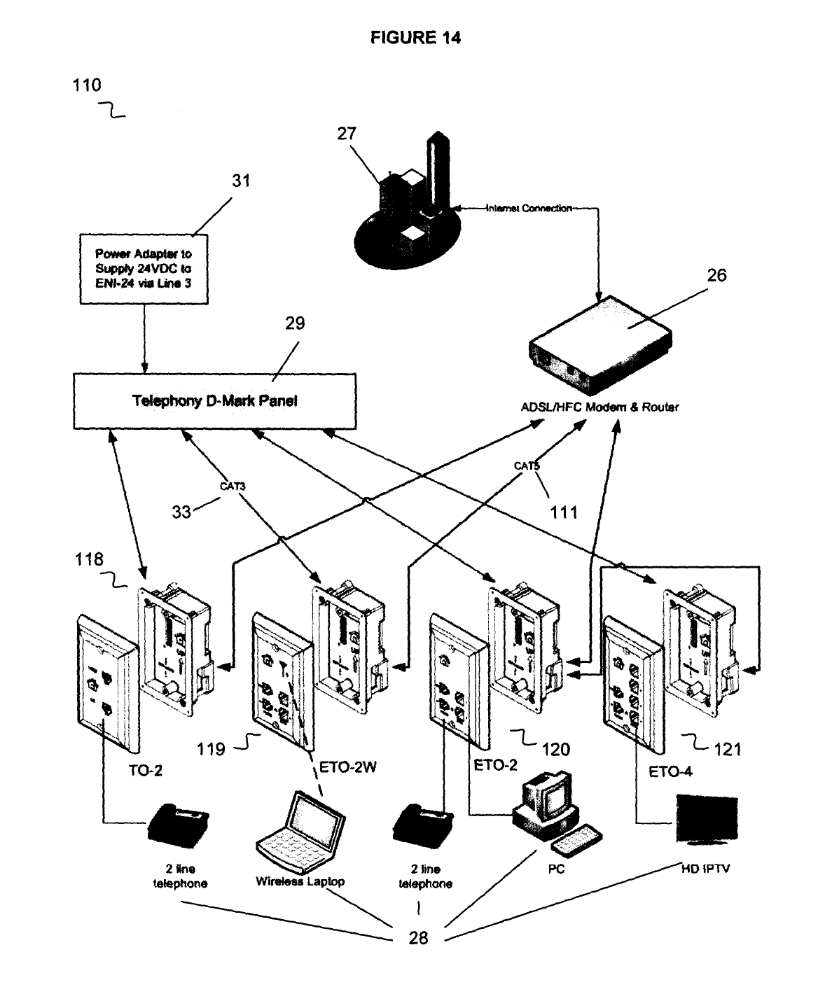

Referring now to FIG. 14, there is depicted an embodiment of a network 110 that uses pre-existing category 5/5e/6 electrical cable 111 to deliver content to consumers. There exist many pre-wired residence and businesses that use electrical Ethernet cable to obtain network connectivity, but are limited in their ability to re-configure or expand their networks. In the embodiments as depicted, the network 110 has network access modules in the form of media converter devices 118, 119, 120, 121, each having a 2-port Ethernet network interface device 130 combined with one of several modular outlet devices 14, 15, 16, 17, that allow a consumer to access the network 110 using one or both of a typical Ethernet cable or a wireless connection. The media converter devices 118, 119, 120, 121 in the embodiment of the network 110 depicted in FIG. 14 also allow a consumer to access a traditional telephony system via phone jacks 22, 23, 24, 25 (not labelled in FIG. 14, but labelled in FIGS. 6 through 13).

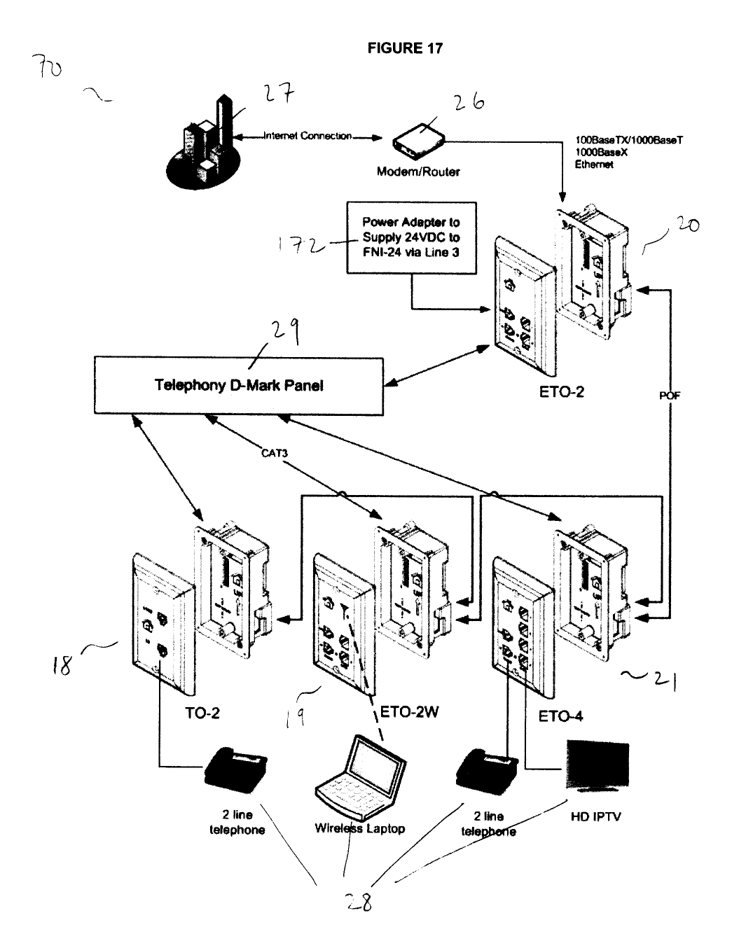

Referring now to FIG. 17, there is depicted an embodiment of a network 170 that uses POF 11 to deliver content to consumers. In the embodiments as depicted, the network 170 has network access modules in the form of media converter devices 18, 19, 20, 21, each having a 2-port POF network interface device 13 combined with one of several modular outlet devices 14, 15, 16, 17, that allow a consumer to access the network 170 using one or both of a typical Ethernet cable or a wireless connection. The media converter devices 18, 19, 20, 21 in the embodiment of the network 10 as depicted in FIG. 1 also allow a consumer to access a traditional telephony system via phone jacks 22, 23, 24, 25 (labelled in FIGS. 6 through 13).

As described in further detail below, such embodiments allow the existing telephony networks present in many buildings, such as residences and businesses, to be utilized and leveraged in connection with the portion of the networks 10, 110 that enable Ethernet connectivity in order to provide both traditional telephony services and Ethernet access to consumers.

### Exemplary Embodiment Using a POF Network

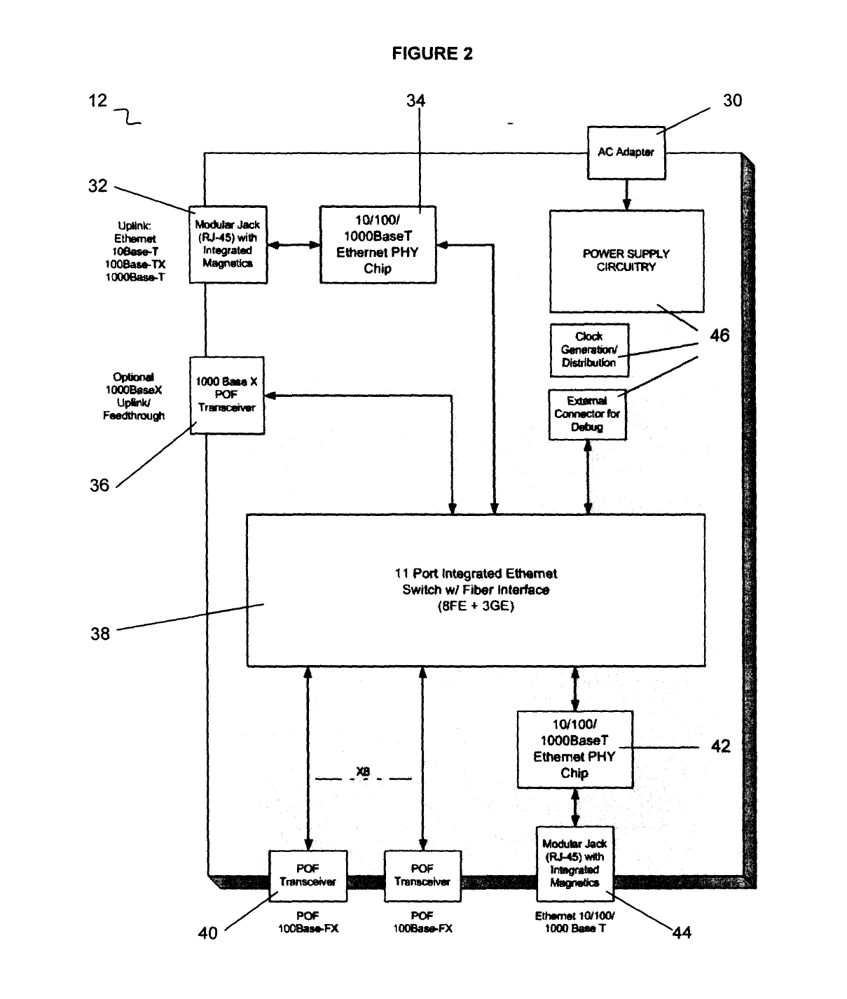

Referring now to FIG. 1, there is depicted a network 10 that uses POF 11 to deliver content to consumers. The network 10 has a modem/router 26, such as a 2-wire Gateway 2700HG-E ADSL modem/router, that bridges the connection between a WAN 27, such as an ADSL Internet connection, and a LAN, such as the 100BaseTX/1000BaseT/1000BaseX Ethernet used in this exemplary embodiment. The Ethernet connection from the modem/router 26 is then coupled to multi-port bi-directional media converter 12, which is discussed in more detail with reference to FIG. 2, below. Instead of connecting an ADSL Internet connection to the modem/router 26, a privately held network's 10/100/1000 Base-T Ethernet connection, such as those used by cable companies to deliver IPTV, can be connected directly to the media converter 12. For installations in a multi-dwelling unit (“MDU”) such as an apartment complex, for example, both the modem/router 26 and media converter 12 are typically housed in a utility space to which multiple services (e.g.: cable, telephone) are directed before being routed throughout the MDU to individual units/residences. In this exemplary embodiment, the media converter 12 is coupled to the 100BaseTX/1000BaseT/1000BaseX electrical Ethernet on its upstream end and to up to eight ports transmitting 100BaseFX Ethernet transmitted over POF 11 on its downstream end. In this application, notwithstanding that the network 10 is bi-directional, “upstream” refers to points in the network nearer to the WAN 27, while “downstream” refers to points in the network nearer to the LAN. The POF 11 can be any suitable POF as is known to persons skilled in the art, such as Mitsubishi International Corporation's ESKA™ 2.2 mm POF. While the POF 11 in FIG. 1 is depicted schematically as one strand of POF, each port of the media converter 12 is coupled to two strands of POF, one for transmitting and one for receiving data, consistent with the 100BaseFX standard.

The POF 11 is wired through a consumer's residence or commercial building, for example. By using POF for wiring, the problem of transients affecting the data transmitted on electrical Ethernet cables, such as standard category 5, 5e, or 6 cables, is eliminated. This is because transients inherently affect only electrical signals, and the signal transmitted along a POF is optical. With transients eliminated, signal interference decreases and a high QOS can be ensured. Consequently, when the POF is being laid in the home or building, within a wall where it is hidden from view, extra care does not have to be taken to separately install shielded conduits that house Ethernet cables, as POF can be laid adjacent to standard electrical wiring, which results in a simpler installation and cost savings. Furthermore, POF can be easily installed by an electrician or by a low-voltage telecommunications technician, as POF is a resilient, easy-to-handle medium that can be safely cut using means such as an X-acto™ knife. This is in contrast to glass optical fiber, which easily shatters, and which therefore cannot be installed at low cost by an electrician or by a low-voltage telecommunications technician.

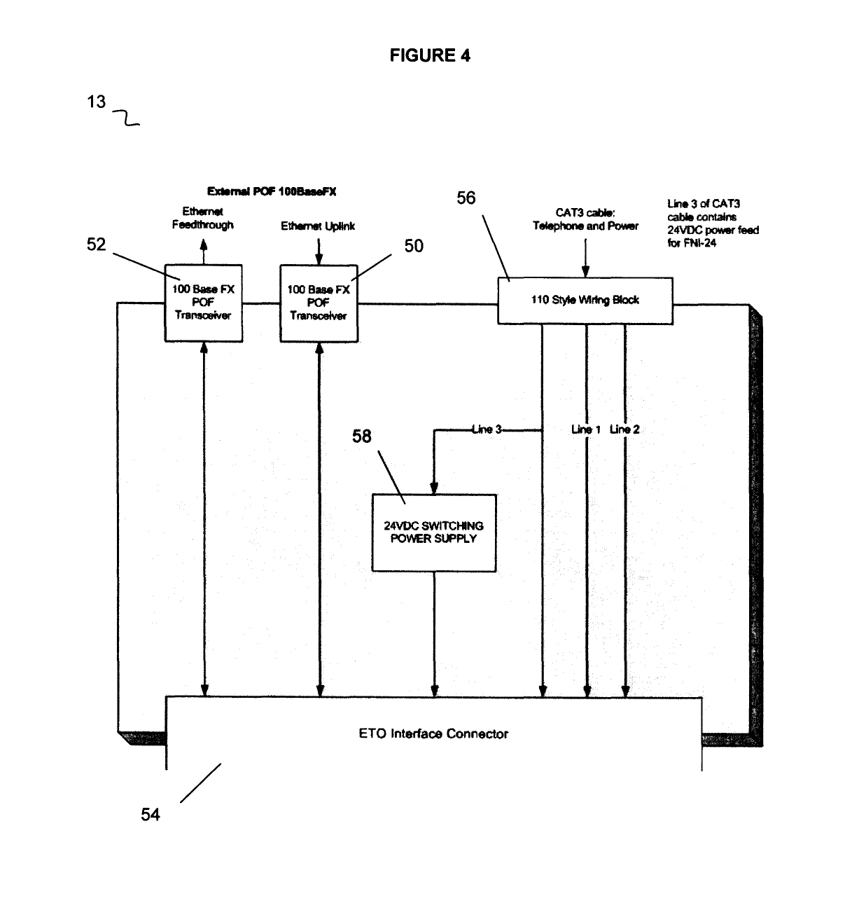

Each POF 11 pair terminates in one of the media converter devices 18, 19, 20, 21 which convert the optical Ethernet signal back into an electrical Ethernet signal for use by an end device 28 such as a computer or television. The media converter devices 18, 19, 20, 21 are discussed in more detail with reference to FIGS. 4-13, below.

The media converter devices 18, 19, 20, 21 all have network access jacks in the form of telephone jacks 22, 23, 24, 25 that allow a consumer to access a traditional telephony network. Such functionality is achieved by connecting media converter devices 18, 19, 20, 21 to a telephonic hub in the form of telephony D-Mark Panel 29 as well as to the media converter 12. The D-Mark Panel 29 represents the point at which the network owned by a telecommunications utility ends, and residential telephony wiring begins. In this sense, the functionality of the D-Mark Panel 29 is analogous to that of the modem/router 26, in that both the D-Mark Panel 29 and modem/router 26 bridge an outside network or system (the telecommunications utility's network and the WAN 27, respectively) with a residential network or system (the residential telephony wiring and the LAN, respectively).

Power for the POF network's media converter devices 18, 19, 20, 21 is realized by use of 24 VDC power supply 31. This power supply 31 is co-located with the media converter 12 and is typically housed in a utility space in the residence or business. Power Supply 31 connects to an unused electrical wire twisted pair within CAT3 telephony cable network 33 to provide power to media converter devices 18, 19, 20, 21 as explained in more detail below. Hereinafter, “telephone cable” includes, but is not limited to, CAT3 cable, regardless of whether the CAT3 or other type of cable is actually being used to transmit voice signals. For example, a CAT3 cable used only to supply power to one of the media converter devices 18, 19, 20, 21 and not to transmit voice signals qualifies as a “telephone cable”.

Referring now to FIG. 2, there is depicted a block diagram of the media converter 12. On the upstream side are two interfaces: an electrical 10Base-T/100Base-TX/1000Base-T Ethernet uplink via an RJ-45 jack 32, and an optional 1000BaseX fiber uplink via a 1000BaseX POF transceiver 36. A typical RJ-45 jack 32 used is a Pulse Magnetics JK0654219 jack; an exemplary 1000BaseX POF transceiver 36 used is the Firecomms™ EDL1000G-510 transceiver. Directly coupled to the RJ-45 jack 32 is a 10/100/1000BaseT Ethernet PHY chip 34, such as the Marvell™ 88E1111, necessary for Ethernet transmissions. Both the RJ-45 jack 32 and the POF transceiver 36 transmit electrical signals to the 11-port Ethernet integrated switch 38. The switch 38 may, for example, be a Marvell™ 88E6097. The switch 38 can interface with the PHY chips 34, 42 using any appropriate interface, such as the SGMII, GMII, RGMII, or MII interfaces. The switch 38 couples the upstream transceivers 32, 36 to the downstream transceivers, which in this exemplary embodiment consist of eight POF transceivers 40, each outputting 100Base-FX Ethernet on to pairs of POF 14, and another RJ-45 jack 44 coupled to the switch 38 via PHY chip 42 and outputting electrical 10/100/1000 Base-T Ethernet signals. No separate PHY chips are required between the switch 38 and the POF transceivers 32, 36, 40, as the switch 38 has integrated PHY-level drives (not shown) for directly driving POF or other fiber devices. Power, clock, and debug circuitry 46 is also present.

Notably, although in this exemplary embodiment the switch 12 is configured such that it couples upstream signals from the WAN 24 to the POF 12 via jack 32, the switch 12 can also be configured to couple other signals to the POF 12, such as a 1000 Base-T POF signal via transceiver 36 or a 10/100 Base-T POF signal from any of the POF transceivers 40.

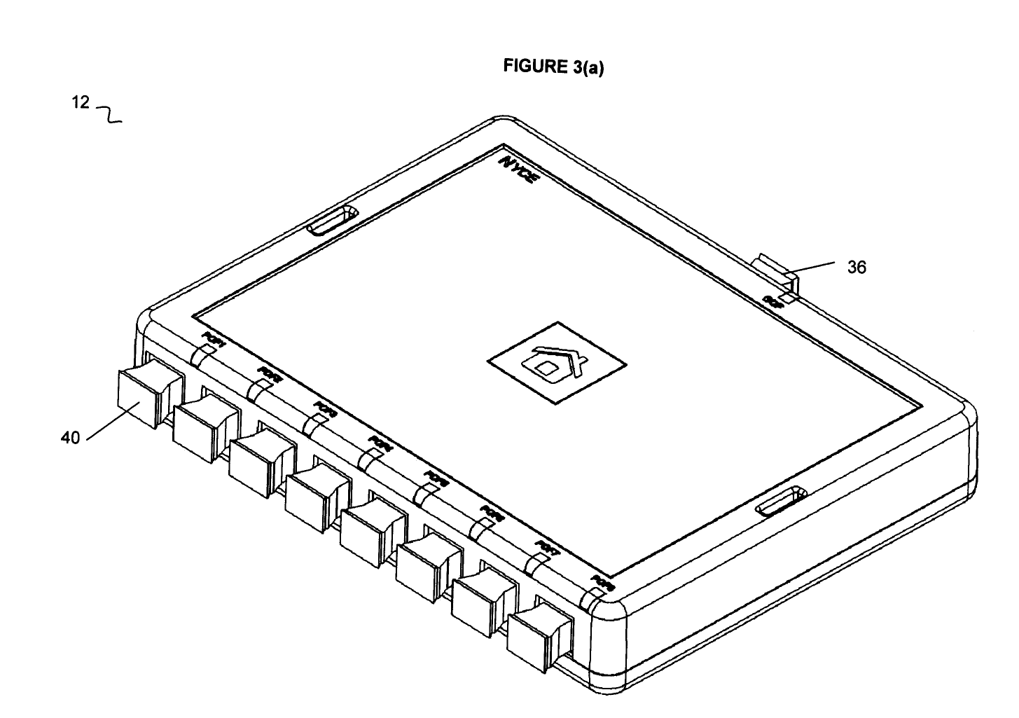

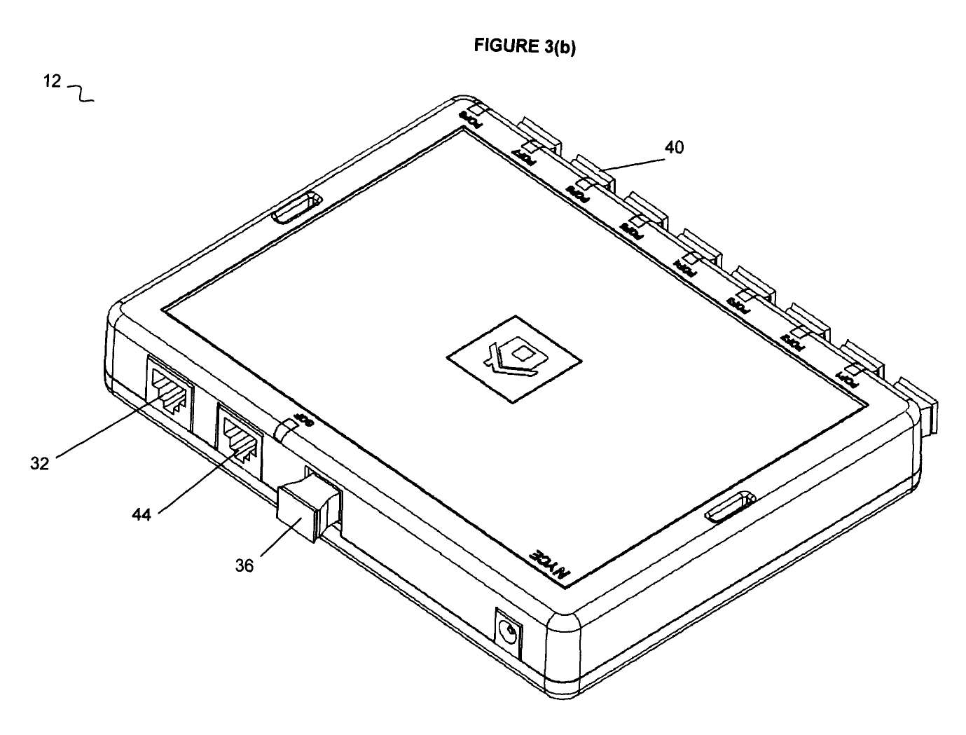

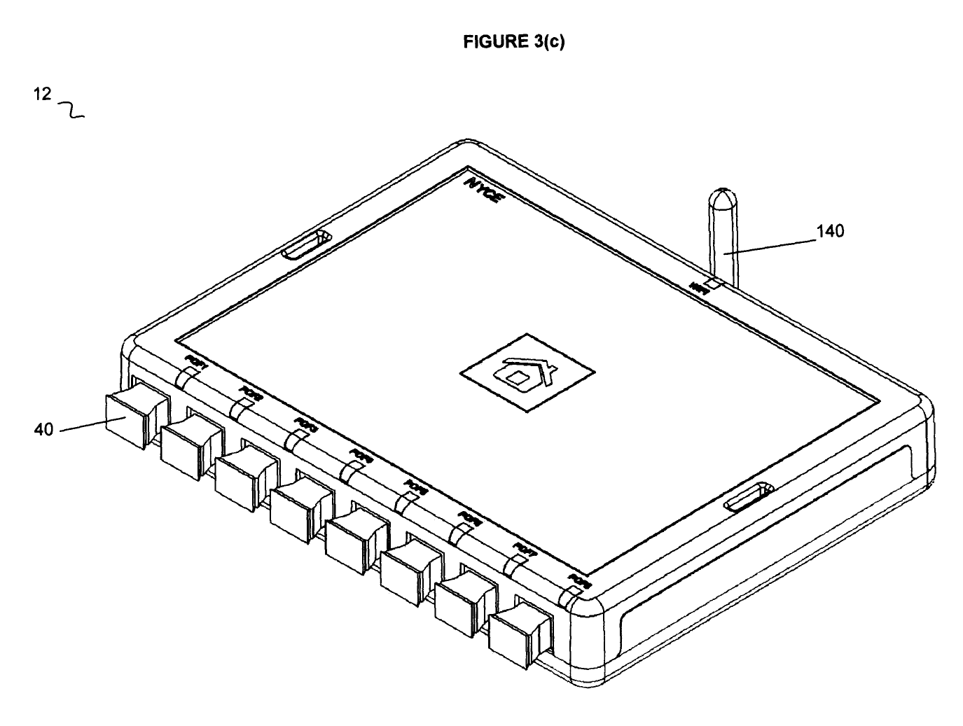

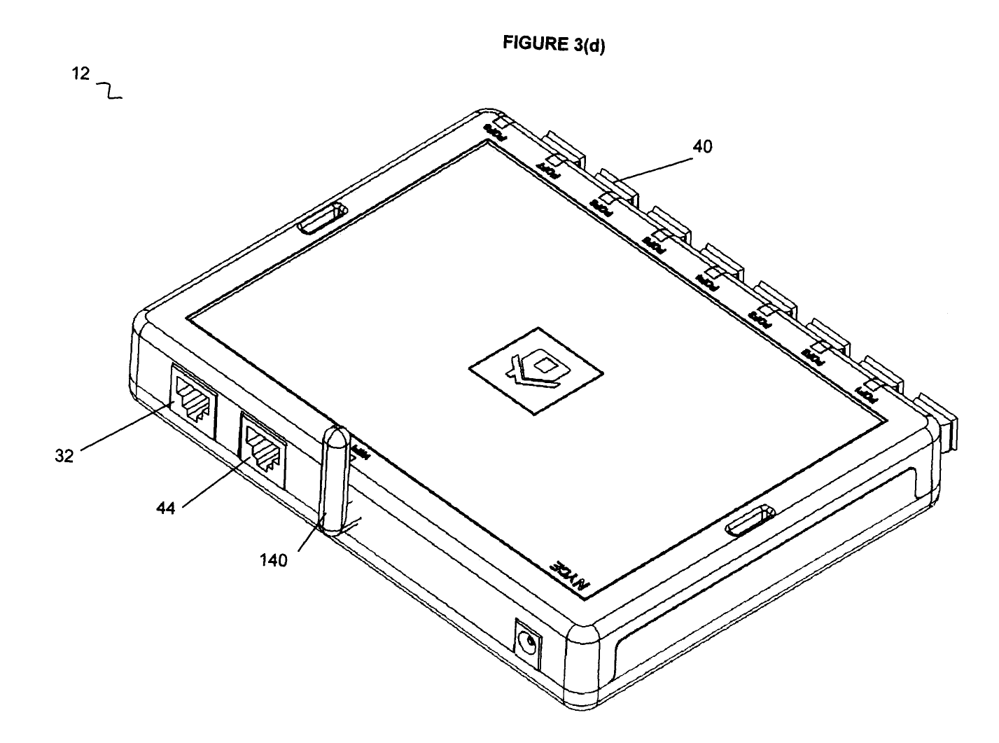

FIGS. 3(a) and 3(b) are perspective views of the media converter 12. Visible are the eight POF switches 40 and the two RJ-45 jacks 32, 44.

FIGS. 3(c) and 3(d) are perspective views of media converter 12 wherein in lieu of the optional 1000BaseX POF Transceiver 36, an external antenna 140 provides the media converter 12 with wireless connectivity. The external antenna 140 is coupled internally to a wireless connectivity module (not shown), such as a Broadcom BCM5352 chip-set or an Atheros AR5002AP-2X chip-set, which module is then coupled to the Ethernet switch 38. The wireless connectivity can be used to wirelessly couple the modem/router 26 to the media converter 12.

Referring now to FIG. 4, there is depicted a block diagram of 2-port POF network interface device 13. The network interface device 13 has as an upstream connector an optical-electrical transceiver in the form of 100 Base FX POF Transceiver 50 coupled electrically to a first interface connector in the form of an Ethernet-Telephony-Outlet (“ETO”) interface connector 54. The ETO interface connector 54 may be, for example, a Samtec CLT Series connector. The network interface device 13 also has a second 100 Base FX POF Transceiver 52 (the “feed-through transceiver”), also coupled electrically to the ETO interface connector 54, that can be used to daisy-chain the network interface device 13 to other network interface devices 13. This allows the other media converter devices 18, 19, 20, 21 to receive an optical Ethernet signal via the feed-through transceiver as opposed to directly from the media converter 12. Such functionality is beneficial as it allows the number of ports on the media converter 12 to be conserved.

The network interface device 13 also has a telephonic network access block in the form of 110-style wiring block 56 electrically coupled to power supply circuitry in the form of a 24 VDC switching power supply 58 and to the ETO interface connector 54. Fed into the wiring block 56 are, for example, twisted pairs from category 3 cable that typically makes up residential telephony wiring. In FIG. 1, the three of the twisted pairs are labelled Lines 1, 2 and 3. Line 3 is used to provide 24 VDC electric power to the network interface device 13 by supplying DC power to the power supply 58, whose output signal is coupled to the ETO interface connector 54. Lines 1, 2 and 3 are each coupled to the ETO interface connector 54. Together, the telephonic network access block and the optical-electrical transceiver are one example of a network access port assembly.

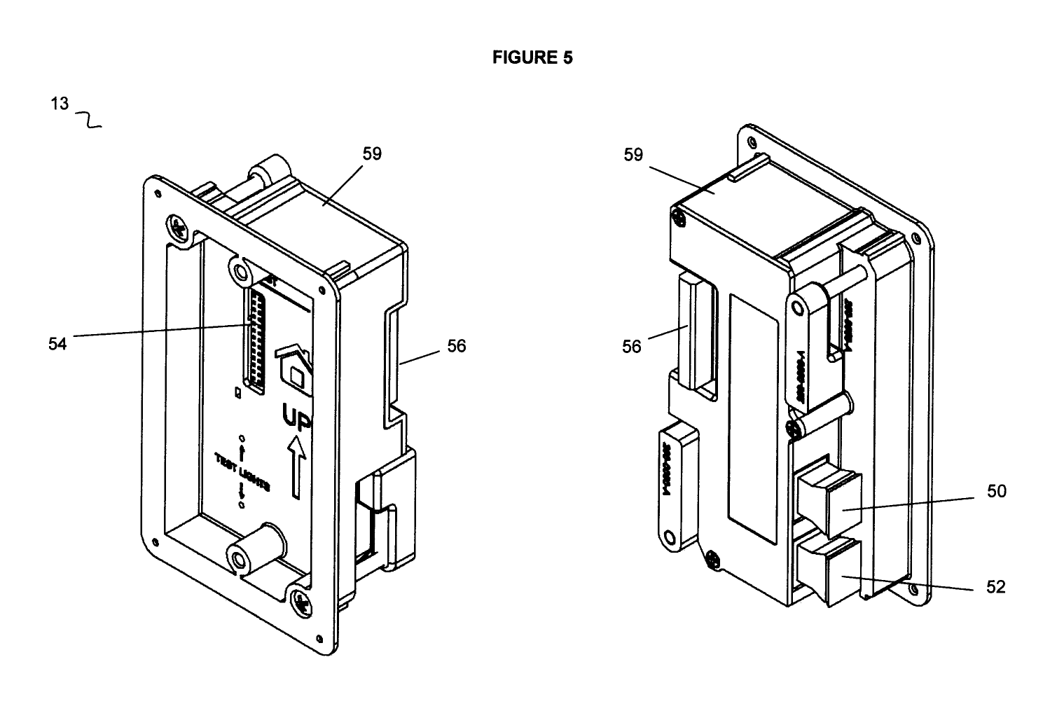

FIG. 5 contains perspective views of the network interface device 13. Visible are the POF Transceivers 50, 52, the ETO interface connector 54, the 110-style wiring block 56 and the physical housing 59 of network interface device 13.

Referring now to FIG. 6, there is depicted a block diagram of 2-port modular outlet device 14. Modular outlet device 14 can be physically and electrically coupled to the first interface connector of the network interface device 13 via a second interface connector in the form of an ETO interface connector 60, which may be, for example, a Samtec TMM Series connector. Coupled to the ETO interface connector 60 is a 6-port Ethernet switch with fiber support 62, such as the Marvell™ 88E6061, which connects the ETO interface connector 60 with signals from optical-electrical transceivers in the form of POF Transceivers 50, 52 to network access jacks in the form of user-side Ethernet jacks in the form of any of two RJ-45 jacks 64 into which are inserted Ethernet cables (not shown) for supplying a network connection to consumer devices 28. The switch 62 used in this exemplary embodiment has four integrated Fast Ethernet transceivers (not shown) that allow the two RJ-45 jacks 64 to be directly coupled to the switch 62; consequently, no external transceivers must be coupled between the switch 62 and any of the RJ-45 jacks 64.

Modular outlet device 14 also contains telephone jacks, which are another type of network access jack, in the form of a 2-port RJ-11 (6P6C) modular telephone jack 22 electrically coupled to the ETO interface connector 60. The three twisted pair telephony signals from the ETO interface connector 60 are labelled Lines 1, 2 and 3. Line 3 can be used to provide 24 VDC electric power to the modular outlet device 14 from an external power supply, as depicted in FIGS. 1, 14 and 17. The electricity can be used to operate power consuming circuitry, such as the Ethernet switch 62 and the optical-electrical transceivers. Lines 1, 2 and 3 are each coupled to one port of the 2-port RJ-11 (6P6C) jack 22, with a consumer being able to plug in a telephone to each of the Line 1 and 2 ports of the RJ-11 (6P6C) jack 22 via a standard RJ-11 plug.

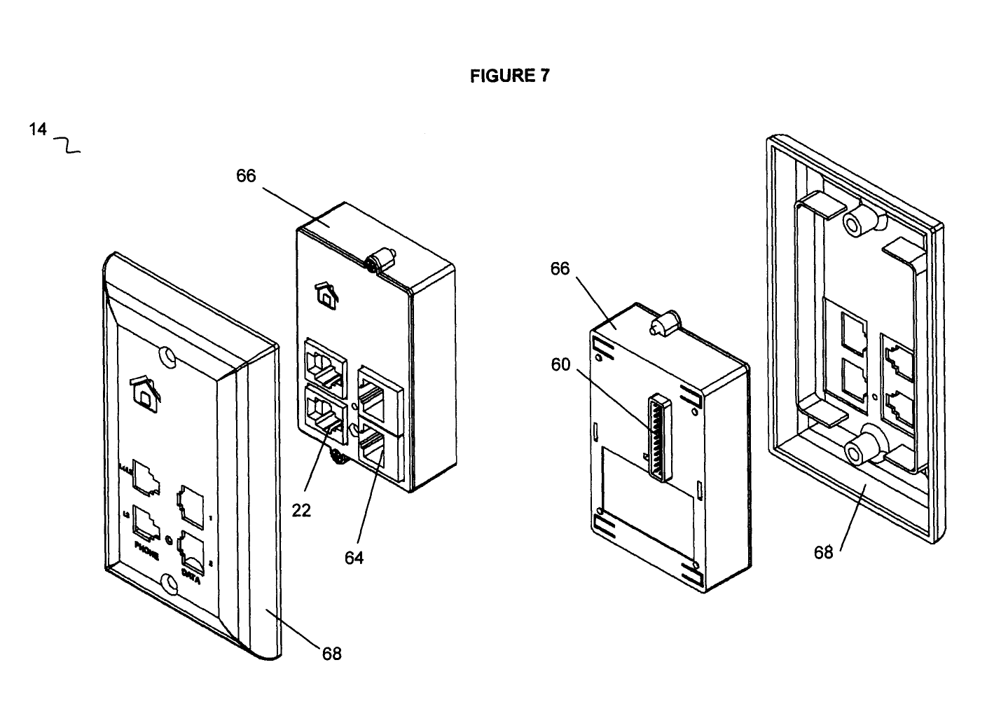

FIG. 7 contains perspective views of the modular outlet device 14. Visible are the 2-port RJ-11 (6P6C) modular telephone jack 22, two RJ-45 jacks 64, the ETO interface connector 60, the physical housing 66 of modular outlet device 14, and a wall cover plate 68 specifically customized for modular outlet device 14.

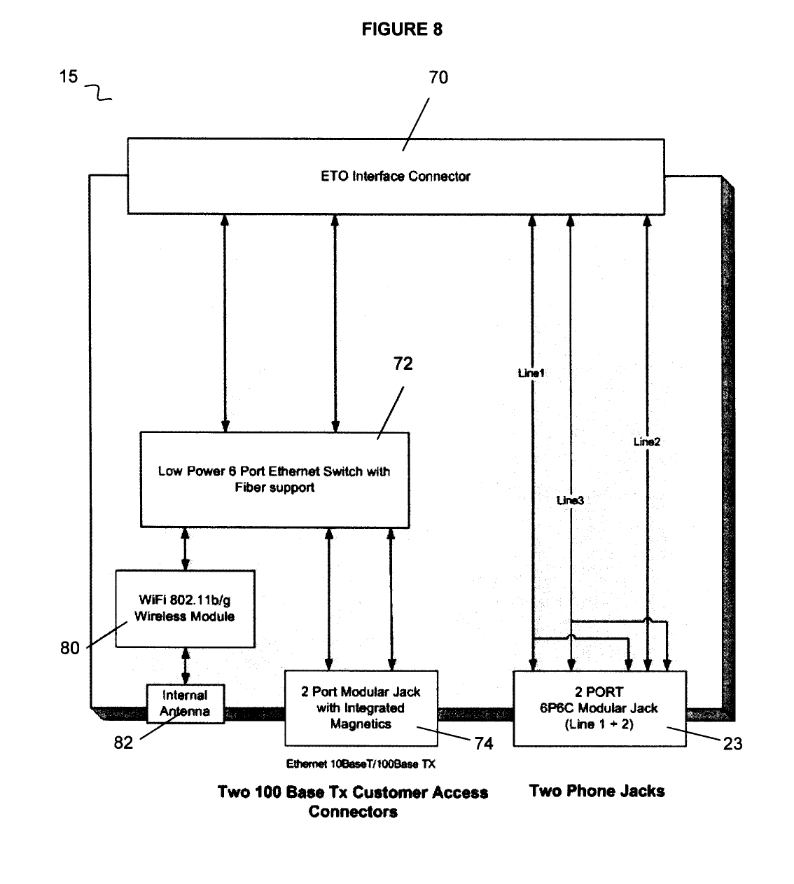

Referring now to FIG. 8, there is depicted a block diagram of 2-port modular outlet device 15 that also supports wireless connectivity. Modular outlet device 15 can be physically and electrically coupled to the first interface connector of the network interface device 13 via a second interface connector in the form of an ETO interface connector 70, which may be, for example, a Samtec TMM Series connector. Coupled to the ETO interface connector 70 is a 6-port Ethernet switch with fiber support 72, such as the Marvell™ 88E6061, which connects the ETO interface connector 70 signals from POF Transceivers 50, 52 to user-side Ethernet jacks in the form of any of two RJ-45 jacks 74 into which are connected Ethernet cables (not shown) for supplying a network connection to consumer devices 28. The switch 72 used in this exemplary embodiment has four integrated Fast Ethernet transceivers (not shown) that allow the two RJ-45 jacks 74 to be directly coupled to the switch 72; consequently, no external transceivers must be coupled between the switch 72 and any of the RJ-45 jacks 74. Also coupled to the switch 72, by means such as the SGMII, GMII, RGMII, or MII interfaces, is a module that allows for wireless connectivity, which in the depicted embodiment is a WiFi™ 802.11 b/g module 80 such as a Broadcom BCM5352 chip-set or an Atheros 2317 chip-set. The wireless connectivity module 80 is coupled to an antenna 82 that facilitates wireless communication with the consumer devices 28.

Modular outlet device 15 also contains telephone jacks in the form of a 2-port RJ-11 (6P6C) modular telephone jack 23 electrically coupled to the ETO interface connector 70. The three twisted pair telephony signals from the ETO interface connector 70 are labelled Lines 1, 2 and 3. Line 3 can be used to provide 24 VDC electric power to the modular outlet device 14 from an external power supply, as depicted in FIGS. 1, 14 and 17. Lines 1, 2 and 3 are each coupled to one port of the 2-port RJ-11 (6P6C) jack 23, with a consumer being able to plug in a telephone to each of the Line1 and 2 ports of the RJ-11 (6P6C) jack 23 via a standard RJ-11 plug.

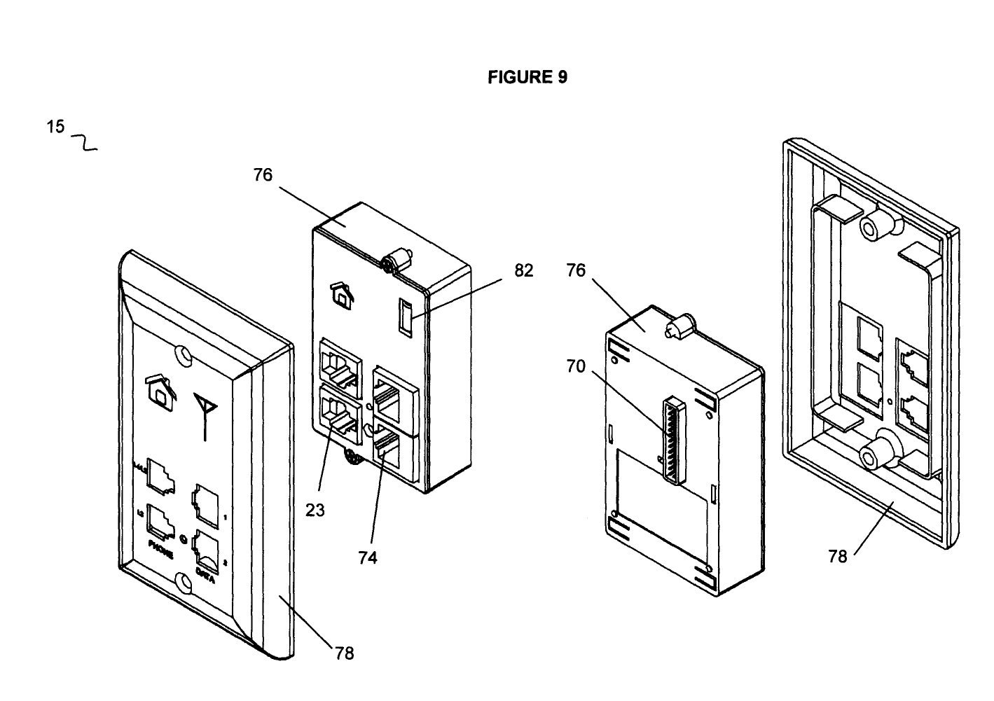

FIG. 9 contains perspective views of the modular outlet device 15. Visible are the 2-port RJ-11 (6P6C) modular telephone jack 23, two RJ-45 jacks 74, the ETO interface connector 70, antenna 82, the physical housing 76 of modular outlet device 15, and a wall cover plate 78 specifically customized for modular outlet device 15.

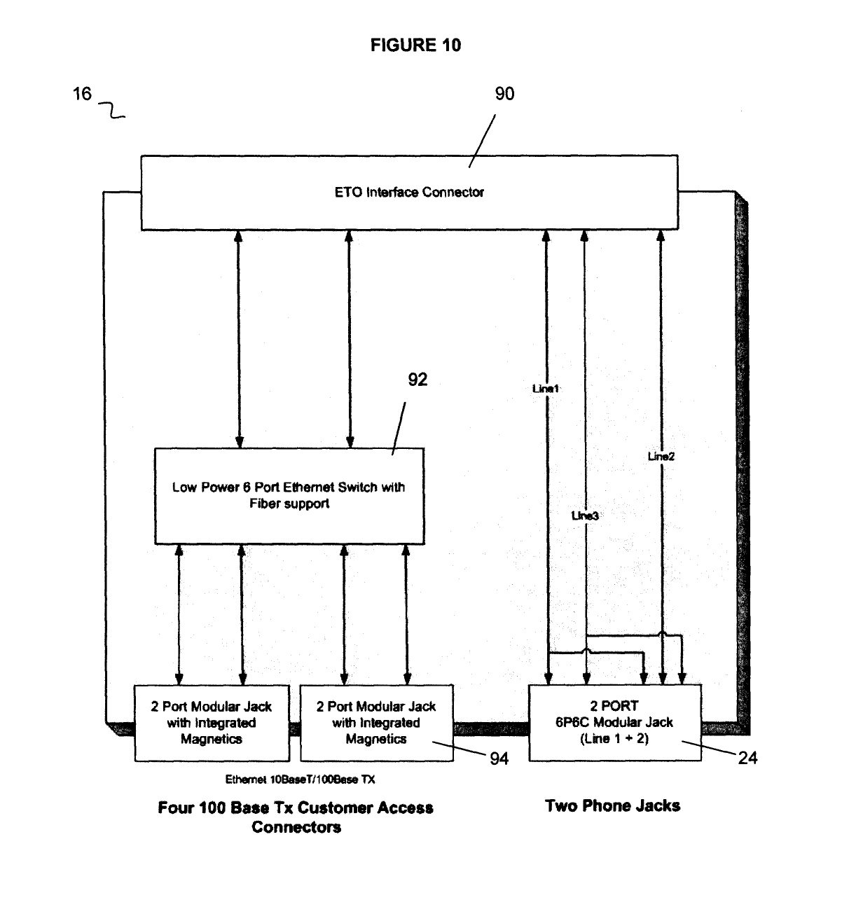

Referring now to FIG. 10, there is depicted a block diagram of 4-port modular outlet device 16. Modular outlet device 16 can be physically and electrically coupled to the first interface connector of the network interface device 13 via a second interface connector in the form of ETO interface connector 90, which may be, for example, a Samtec TMM Series connector. Coupled to the ETO interface connector 90 is a multi-port Ethernet switch with fiber support 92, such as the Marvell™ 88E6083, which connects the ETO interface connector 90 signals from optical-electrical transceivers in the form of POF Transceivers 50, 52 to user-side Ethernet jacks in the form of any of four RJ-45 jacks 94 into which are connected Ethernet cables (not shown) for supplying a network connection to consumer devices 28. The switch 92 used in this exemplary embodiment has multiple integrated Fast Ethernet transceivers (not shown) that allow the four RJ-45 jacks 94 to be directly coupled to the switch 92; consequently, no external transceivers must be coupled between the switch 92 and any of the RJ-45 jacks 94.

Modular outlet device 16 also contains a telephone jack in the form of a 2-port RJ-11 (6P6C) modular telephone jack 24 electrically coupled to the ETO interface connector 90. The three twisted pair telephony signals from the ETO interface connector 90 are labelled Lines 1, 2 and 3. Line 3 can be used to provide 24 VDC electric power to the modular outlet device 14 from an external power supply, as depicted in FIGS. 1, 14 and 17. Lines 1, 2 and 3 are each coupled to one port of the 2-port RJ-11 (6P6C) jack 24, with a consumer being able to plug in a telephone to each of the Line1 and 2 ports of the RJ-11 (6P6C) jack 24 via a standard RJ-11 plug.

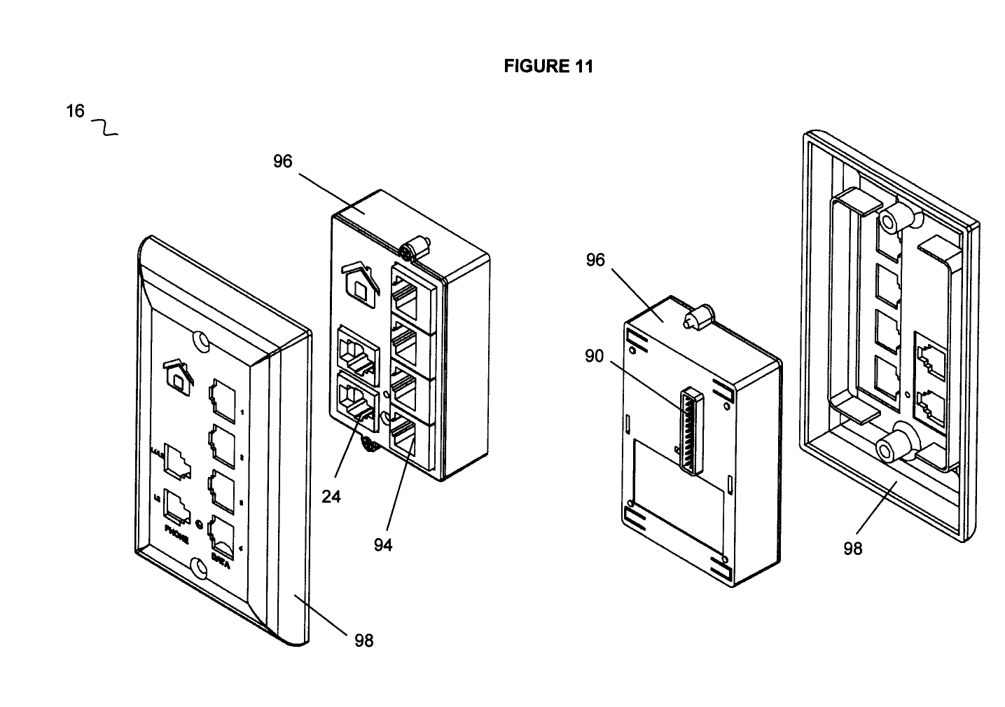

FIG. 11 contains perspective views of the modular outlet device 16. Visible are the 2-port RJ-11 (6P6C) modular telephone jack 24, four RJ-45 jacks 94, the ETO interface connector 90, the physical housing 96 of modular outlet device 16, and a wall cover plate 98 specifically customized for modular outlet device 16.

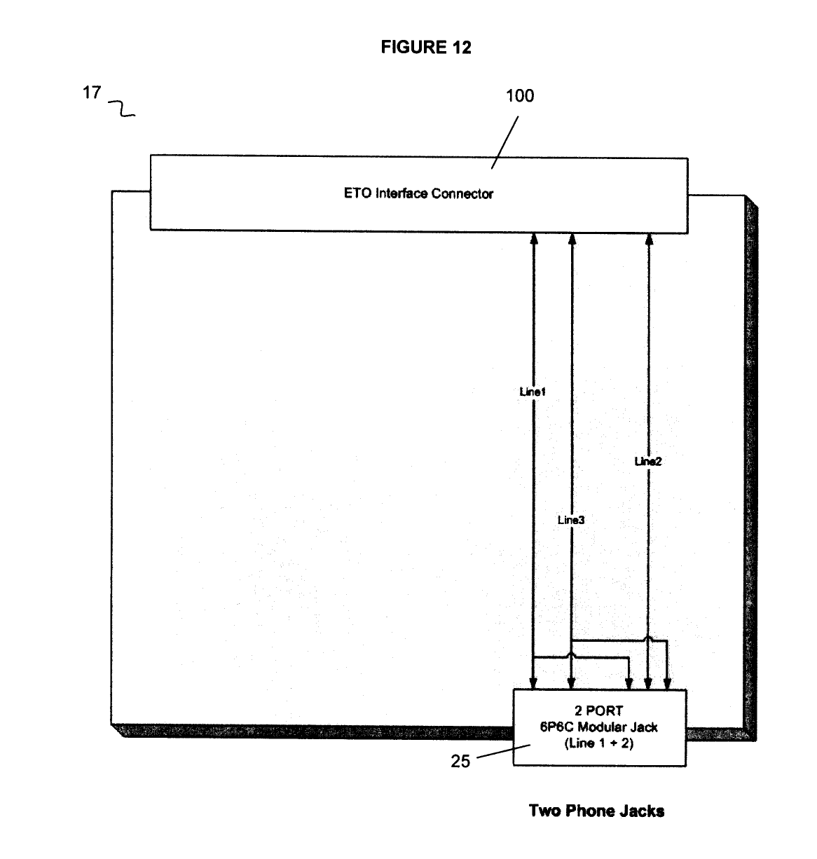

Referring now to FIG. 12, there is depicted a block diagram of 2-port modular outlet device 17. Modular outlet device 17 contains a telephone jack in the form of a 2-port RJ-11 (6P6C) modular telephone jack 25 electrically coupled to an ETO interface connector 100, which may be, for example, a Samtec TMM Series connector. The three twisted pair telephony signals from the ETO interface connector 100 are labelled Lines 1, 2 and 3. Line 3 can be used to provide 24 VDC electric power to the modular outlet device 14 from an external power supply, as depicted in FIGS. 1, 14 and 17. Lines 1, 2 and 3 are each coupled to one port of the 2-port RJ-11 (6P6C) jack 25, with a consumer being able to plug in a telephone to each of the Line1 and 2 ports of the RJ-11 (6P6C) jack 25 via a standard RJ-11 plug.

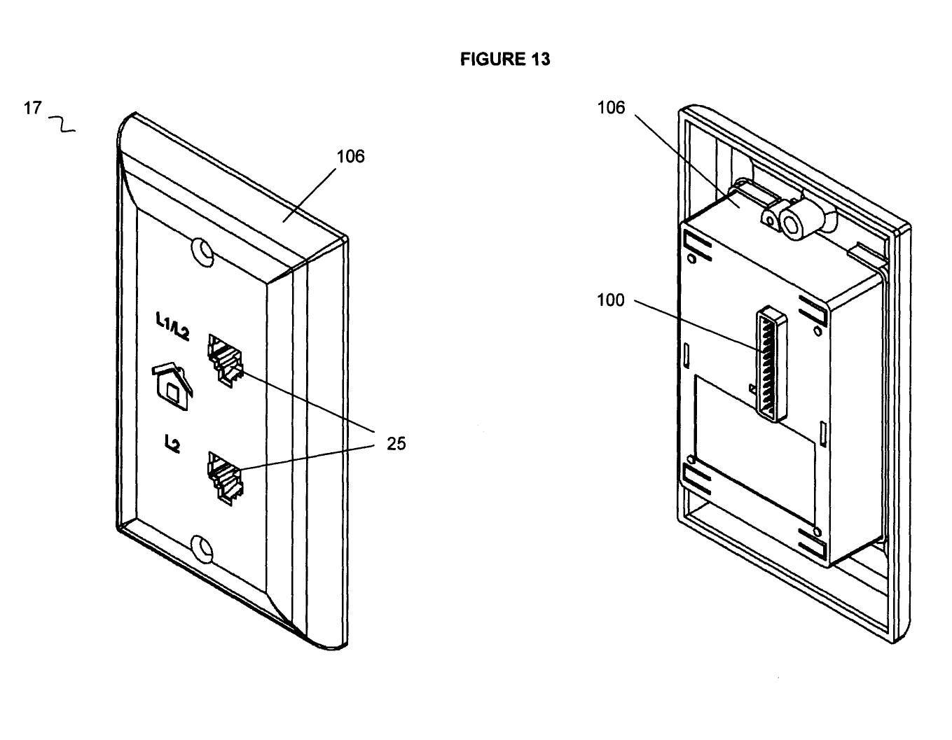

FIG. 13 contains perspective views of the modular outlet device 17. Visible are the 2-port RJ-11 (6P6C) modular telephone jack 25, the ETO interface connector 100 and the physical housing with integrated wall cover plate 106 of modular outlet device 17.

In the embodiments described above, the pin mappings of the ETO interface connector of the network interface device 13 and of the ETO interface connectors of the modular outlet devices 14, 15, 16, 17 are configured to allow for the transmission of Ethernet and telephony signals between the network interface device 13 and the modular outlet devices 14, 15, 16, 17 as required, as well as to allow power to be conducted from the network interface device 13 to the modular outlet devices 14, 15, 16, 17 so as to power the modular outlet devices 14, 15, 16, 17.

FIG. 5 shows network interface device 13 with housing 59 that can be conveniently fitted within a wall, thereby allowing easy and ubiquitous access to a high QOS network connection. Because the optical signals in POF network 11 are not affected by transients, media converter devices 18, 19, 20, 21 can be placed adjacent to the sources of transients, such as AC power lines, without suffering signal degradation. The POF transceivers 50, 52 of network interface device 13 can receive and transmit POF signals in a daisy-chained fashion. Such a daisy-chained POF network 11 can be routed under the baseboards or through the walls of a residence, for example, to reduce any detrimental aesthetic or functional affect on the residence. Benefits of mounting the modular outlet devices 14, 15, 16, 17 within network interface device 13 include ease of installation, as telecommunications technicians, electricians and consumers can easily terminate the POF into a convenient receptacle, and convenience of use, as network interface device 13 can be located in several places in a typical home, and consequently can provide for easy and ubiquitous network access. Furthermore, in contrast to current high QOS network installations that rely on multiple runs of Ethernet cables, all network connections provided by this exemplary embodiment are capable of providing a high QOS network connection. A consumer can plug a device, such as a television or a computer, into any of the jacks 64, 74, 94 of media converter devices 19, 20, 21 and access a network with a high QOS sufficient for IPTV, for example, as opposed to having to select a specific network jack that is coupled to Ethernet cabling that is sufficiently protected from transients to provide a high QOS connection.

One design challenge that had to be overcome in order to fit network interface device 13 and modular outlet devices 14, 15, 16, 17 within the housings 59, 66, 76, 96, 106 is that of using space efficiently. With respect specifically to the modular outlet devices 14, 15, 16 contained within the housings 66, 76, 96, using the POF transceivers 50, 52 within network interface device 13, is advantageous, as the Ethernet switches 62, 72, 92, have integrated PHY-level drives for interfacing with the POF transceivers 50, 52 thus obviating the need for a discrete PHY transceiver and thereby saving space. Separate PHY transceivers, such as a Marvell™ 88E3015 transceiver, would have had to be used to transmit Ethernet signals transmitted solely via electrical RJ-45 jacks instead of POF transceivers, which would have resulted in terminators having a form factor too large to fit within the housings 66, 76, 96. In the exemplary embodiments described herein, the housing 59 that is to be housed within a wall is only 1.1″ deep.

One benefit of the aforedescribed embodiments is that the use of POF within a building eliminates the problem of transients, and thus a telecommunications utility does not have to lay multiple conduits of wire in order to ensure signal quality. Instead, POF can be laid in close proximity to wiring conveying AC power, other networking and traditional telephony signals. An additional benefit is that POF is a medium that can be handled and installed easily by a typical electrician or low-voltage telecommunications technician, in contrast to glass optical fiber, and consequently requires less specialized labor and is cheaper to install.

### Exemplary Embodiment Using a Pre-existing Ethernet Network

Referring now to FIG. 14, there is depicted a network 110 that uses pre-existing category 5/5e/6 electrical cable 111 to deliver content to consumers. The network 110 has a modem/router 26, such as a 2-wire Gateway 2700HG-E ADSL modem/router, that bridges the connection between a WAN 27, such as an ADSL Internet connection, and a LAN, such as the 100BaseTX/1000BaseT/1000BaseX Ethernet used in this exemplary embodiment. Instead of connecting an ADSL Internet connection to the modem/router 26, a privately held network's 10/100/1000 Base-T Ethernet connection, such as those used by cable companies to deliver IPTV, can be connected directly to the modem/router 26. For installations in a multi-dwelling unit (“MDU”) such as an apartment complex, for example, modem/router 26 is typically housed in a utility space to which multiple services (e.g.: cable, telephone) are directed before being routed throughout the MDU to individual units/residences. In this exemplary embodiment, the modem/router 26 is coupled to the 100BaseTX/1000BaseT/1000BaseX electrical Ethernet on its upstream end and to multiple ports transmitting 100BaseFX electrical Ethernet on its downstream end. In this application, notwithstanding that the network 110 is bi-directional, “upstream” refers to points in the network nearer to the WAN 27, while “downstream” refers to points in the network nearer to the LAN. The category 5/5e/6 electrical cable 111 can be any suitable cable as is known to persons skilled in the art, such as General Cable 24AWG 4PR 2133629CAH Category 5e. While the electrical cable 111 in FIG. 14 is depicted schematically as one strand of cable, each port of the modem/router 26 is coupled to four twisted pairs with the cable, one for transmitting and one for receiving data, consistent with the 100BaseFX standard.

Each category 5/5e/6 electrical cable 111 terminates in media converter devices 118, 119, 120, 121 which convey the optical Ethernet signal to an end device 28 such as a computer or television.

The media converter devices 118, 119, 120, 121 all have telephone jacks 22, 23, 24, 25 that allow a consumer to access a traditional telephony network. Such functionality is achieved by connecting media converter devices 118, 119, 120, 121 to a telephonic hub in the form of telephony D-Mark Panel 29 as well as to modem/router 26. The D-Mark Panel 29 represents the point at which the network owned by a telecommunications utility ends, and residential telephony wiring begins. In this sense, the functionality of the D-Mark Panel 29 is analogous to that of the modem/router 26, in that both the D-Mark Panel 29 and modem/router 26 bridge an outside network or system (the telecommunications utility's network and the WAN 27, respectively) with a residential network or system (the residential telephony wiring and the LAN, respectively).

Power for the network's media converter devices 118, 119, 120, 121 is realized by use of 24 VDC power supply 31. This power supply 31 is co-located with modem/router 26 and is typically housed in a utility space in the residence or business. Power supply 31 connects to an unused electrical wire twisted pair within a telephone cable, such as CAT3 telephony cable used in network 33, to provide power to media converter devices 118, 119, 120, 121.

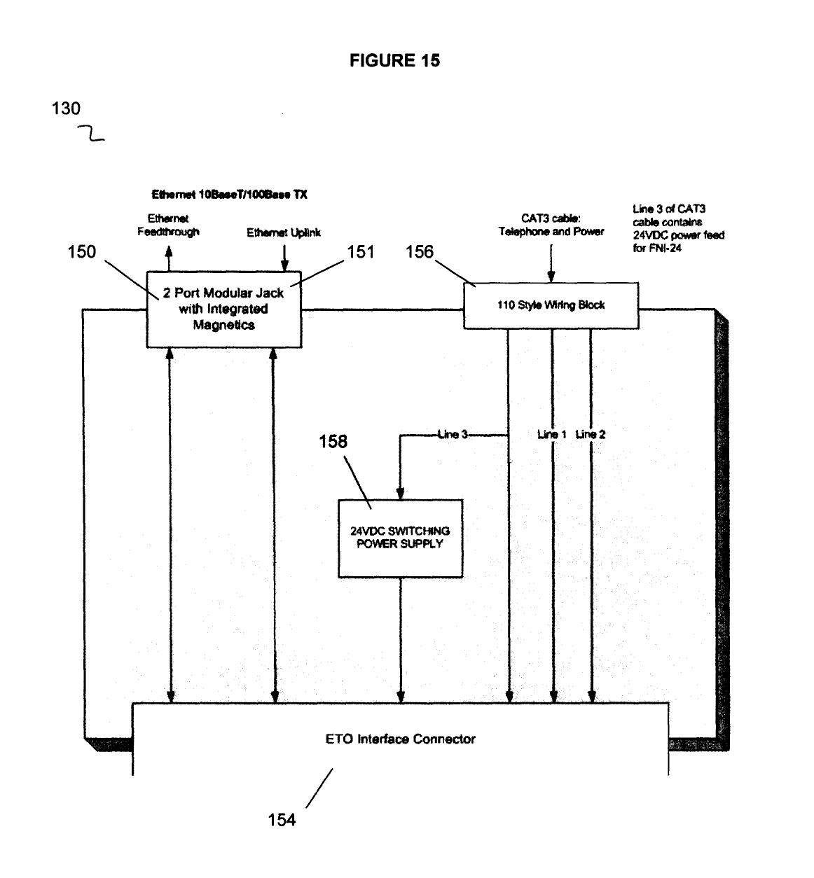

Referring now to FIG. 15, there is depicted a block diagram of 2-port Ethernet network interface device 130. The network interface device 130 has as an upstream connector network-side Ethernet jack in the form of an RJ-45 jack 150 coupled electrically to a first interface connector in the form of an ETO interface connector 154, which can be, for example, a Samtec CLT Series connector. The network interface device 130 also has a second RJ-45 jack 151 (the “feed-through”), also coupled electrically to the ETO interface connector 154, that can be used to daisy-chain the network interface device 15 to other network interface devices 15. This allows the other media converter devices 118, 119, 120, 121 to receive an electrical Ethernet signal via the feed-through as opposed to directly from the modem/router 26. Such functionality is beneficial as it allows the number of ports on the modem/router 26 to be conserved.

The network interface device 15 also has a telephonic network access block in the form of a 110-style wiring block 156 electrically coupled to a 24 VDC switching power supply 158 and to the ETO interface connector 154. Fed into the wiring block 156 are, for example, twisted pairs from category 3 cable that typically makes up residential telephony wiring. In FIG. 15, the three of the twisted pairs are labelled Lines 1, 2 and 3. Line 3 is used to provide 24 VDC electric power to the network interface device 15 by supplying DC power to the power supply 158, whose output signal is coupled to the ETO interface connector 54. Lines 1, 2 and 3 are each coupled to the ETO interface connector 154. Together, the telephonic network access block and the network-side Ethernet jack are one example of a network access port assembly.

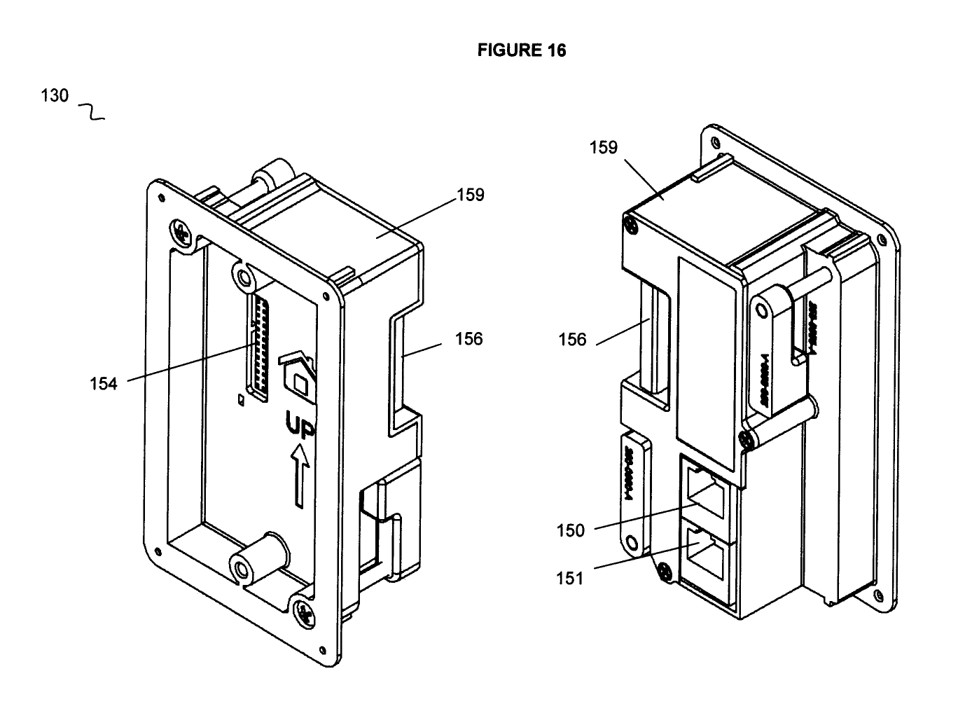

FIG. 16 contains perspective views of the network interface device 130. Visible are the RJ-45 jacks 150, 151, the ETO interface connector 154, the 110-style wiring block 156 and the physical housing 159 of network interface device 15.

The pin mappings of the ETO interface connector 154 of the network interface device 130 and of the ETO interface connectors of the modular outlet devices 14, 15, 16, 17 are configured to allow for the transmission of Ethernet and telephony signals between the network interface device 130 and the modular outlet devices 14, 15, 16, 17 as required, and are configured to allow power to be conducted from the network interface device 130 to the modular outlet devices 14, 15, 16, 17 so as to power the modular outlet devices 14, 15, 16, 17.

### Exemplary Embodiment Using a Distributed POF Network

Referring now to FIG. 17, there is depicted a network 170 that uses POF 11 to deliver content to consumers. The network 170 has a modem/router 26, such as a 2-wire Gateway 2700HG-E ADSL modem/router, that bridges the connection between a WAN 27, such as an ADSL Internet connection, and a LAN, such as the 100BaseTX/1000BaseT/1000BaseX Ethernet used in this exemplary embodiment. In this embodiment, the ADSL Internet and Telephony installation points are not co-located within the building or residence, nor is there a convenient source of electrical power near D-Mark Panel 29, the Telephony installation point. In such an embodiment, a single multi-port bi-directional media converter 12 is typically not used, nor can 24 VDC power supply 31 be easily connected to Line 3 at D-Mark Panel 29. The Ethernet connection from the modem/router 26 is instead coupled to any one of media converter devices 18, 19, 20, 21 (shown as device 20 in this embodiment). Instead of connecting an ADSL Internet connection to the modem/router 26, a privately held network's 10/100/1000 Base-T Ethernet connection, such as those used by cable companies to deliver IPTV, can be connected directly to media converter device 20. In this exemplary embodiment, media converter device 20 is coupled to the 100BaseTX/1000BaseT/1000BaseX electrical Ethernet on its upstream end and up to two ports transmitting 100BaseFX Ethernet transmitted over POF 11 on its downstream end. In this application, notwithstanding that the network 170 is bi-directional, “upstream” refers to points in the network nearer to the WAN 27, while “downstream” refers to points in the network nearer to the LAN. The POF 11 can be any suitable POF as is known to persons skilled in the art, such as Mitsubishi International Corporation's ESKA™ 2.2 mm POF. While the POF 11 in FIG. 17 is depicted schematically as one strand of POF, each port of the media converter device 20 is coupled to two strands of POF, one for transmitting and one for receiving data, consistent with the 100BaseFX standard. Using POF in this embodiment confers the same benefits with respect to, for example, eliminating transients and ease of installation as described above.

Each POF 11 pair terminates in media converter devices 18, 19, 21 which convert the optical Ethernet signal back into an electrical Ethernet signal for use by an end device 28 such as a computer or television. In such an embodiment, because network connections are established through the use of “daisy-chaining” POF connections between media converter devices 18, 19, 21 (as shown in FIG. 17 with devices 19 and 21), the network 170 is less akin to a single-point “star network” as are the networks of the aforedescribed embodiments. In the embodiment as depicted in FIG. 17, the use of “daisy-chaining” allows for greater ease of installation, thereby reducing installation costs.

The media converter devices 18, 19, 20, 21 all have telephone jacks 22, 23, 24, 25 (labelled in FIGS. 6 through 13) that allow a consumer to access a traditional telephony network. Such functionality is achieved by connecting media converter devices 18, 19, 20, 21 to a telephonic hub in the form of telephony D-Mark Panel 29. The D-Mark Panel 29 represents the point at which the network owned by a telecommunications utility ends, and residential telephony wiring begins. In this sense, the functionality of the D-Mark Panel 29 is analogous to that of the modem/router 26, in that both the D-Mark Panel 29 and modem/router 26 bridge an outside network or system (the telecommunications utility's network and the WAN 27, respectively) with a residential network or system (the residential telephony wiring and the LAN, respectively).

Power for the POF network's media converter devices 18, 19, 20, 21 is realized by use of 24 VDC power supply 172. This power supply 172 could be located with or alongside any one of media converter devices 18, 19, 20, 21; in FIG. 17, the power supply 172 is located near the media converter device 20. The power supply 172 is connected to and supplies power through any one or more of telephone jacks 22, 23, 24, 25 of the media converter device 20, through power wiring contained within the media converter device 20, and out the 110 style wiring block 56 of the media converter device 20 to an unused electrical wire twisted pair within a telephone cable that is electrically coupled to the 110 style wiring block 56. The telephone cable extends to the D-mark panel 29, where the power carrying wires within the telephone cable that is coupled to the media converter device 20 are shorted to unused twisted pairs in telephone cables that electrically couple the D-mark panel 29 to the other media converter devices 18, 19, 21. The power supply 172 can thus supply power to the media converter devices 18, 19, 21 via the media converter device 20 and the D-mark panel 29. Notably, this embodiment is particularly useful when retrofitting the network infrastructure of a building, for example. The building in question may not have been designed such that a power supply can be co-located near the D-mark panel 29; by supplying power through the media converter device 20, which is remotely located from the D-mark panel 29, the remaining media converter devices 18, 19, 21 can nonetheless be powered via telephone cable extending from the D-mark panel 29.

While particular embodiments of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. The invention is therefore to be considered limited solely by the scope of the appended claims.

1. A network access module for allowing a user to access a network, the module comprising:
(a) a network interface device comprising:
(i) a network access port assembly communicatively connectable with the network; and
(ii) a first interface connector communicatively connected to the first network access port; and
(b) a modular outlet device comprising:
(i) a network access jack configured to accept a plug of a network communication cable; and
(ii) a second interface connector communicatively connected to the jack;
the network interface and modular outlet devices each comprising a releasable coupling configured to physically couple the network interface and modular outlet devices together such that the first and second interface connectors are communicatively connected to each other.

2. A network access module as claimed in claim 1 wherein the first network access port assembly is configured to receive power from the network, and the network interface device further comprises power supply circuitry electrically connected to the first network access port to receive power therefrom.

3. A network access module as claimed in claim 2 wherein the modular outlet device further comprises power consuming circuitry, the first interface connector comprises a power contact that is electrically coupled to the power supply circuitry and the second interface connector comprises a power contact that is electrically coupled to the power consuming circuitry within the modular outlet device, the power contacts of the first and second interface connectors positioned to contact each other when the modular outlet device is physically coupled to the network access module by the releasable couplings such that the modular outlet device is powered when physically coupled to the network interface device.

4. A network access module as claimed in claim 3 wherein the network access port assembly further comprises a telephonic network access block connectable to a telephone cable and configured to allow access to a telephonic network.

5. A network access module as claimed in claim 4 wherein the telephone cable comprises power carrying wires that supply power to the power supply circuitry via the telephone cable when the telephone cable is connected to the telephonic network access block.

6. A network access module as claimed in claim 5 wherein the network access port assembly further comprises a network-side Ethernet jack configured to accept a network-side Ethernet plug carrying an electrical signal, thereby allowing access to an Ethernet network.

7. A network access module as claimed in claim 6 wherein the network access jack comprises:
(a) a user-side Ethernet jack; and
(b) a telephone jack;
wherein the first interface connector is communicatively connected to the network-side Ethernet jack and to the telephonic network access block, and the second interface connector is communicatively connected to the user-side Ethernet jack and the telephone jack, and the first and second interface connectors are configured so that when connected to each other the network-side and user-side Ethernet jacks are in communications, and the telephonic network access block and telephone jack are in communication.

8. A network access module as claimed in claim 7 wherein the modular outlet device further comprises an Ethernet switch communicatively coupled between the second interface connector and the user-side Ethernet jack, thereby facilitating transmission of Ethernet signals.

9. A network access module as claimed in claim 5 wherein the network access port assembly further comprises an optical-electrical transceiver configured to receive an optical fiber from an optical Ethernet network and to allow access to the optical Ethernet network by enabling bi-directional conversion between optical and electrical network signals.

10. A network access module as claimed in claim 9 wherein the network access jack comprises:
(a) a user-side Ethernet jack; and
(b) a telephone jack;
wherein the first interface connector is communicatively connected to the network-side Ethernet jack and to the telephonic network access block, and the second interface connector is communicatively connected to the user-side Ethernet jack and the telephone jack, and the first and second interface connectors are configured so that when connected to each other the network-side and user-side Ethernet jacks are in communications, and the telephonic network access block and telephone jack are in communication.

11. A network access module as claimed in claim 10 wherein the modular outlet device further comprises an Ethernet switch communicatively coupled between the second interface connector and the user-side Ethernet jack, thereby facilitating transmission of Ethernet signals.

12. A system for allowing a user to access a network, the system comprising:
(a) a router in electrical communication with the network; and
(b) a first network access module as claimed in claim 1 that is communicatively coupled with the router via the network access port assembly.

13. A system as claimed in claim 12 further comprising:
(a) a telephonic hub in electrical communication with a telephonic network; and
(b) a telephone cable,
wherein the network access port of the first network access module is communicatively coupled to the telephonic hub via the telephone cable.

14. A system as claimed in claim 13 further comprising a power supply in electrical communication with the telephonic hub and wherein the telephone cable comprises a pair of power carrying wires in electrical communication with the power supply.

15. A system as claimed in claim 14 further comprising a bi-directional media converter disposed between the router and the first network access module and configured to bi-directionally convert between electrical and optical signals, the bi-directional media converter in electrical communication with the router and in optical communication with the optical-electrical transceiver of the first network access module.

16. A system as claimed in claim 15 wherein the bi-directional media converter comprises a second network access module as claimed in any one of claims 8 to 10, the network access port of the second network access module is electrically coupled to the router, and the optical-electrical transceiver of the second network access module is optically coupled to the optical-electrical transceiver of the first network access module.

17. A system as claimed in claim 16 wherein the second network access module is disposed between the power supply and the telephonic hub and further comprising a second telephone cable comprising a pair of power carrying wires, the power supply electrically coupled to the telephone jack of the second network access module and the telephone hub electrically coupled to the telephonic network access block of the second network access module, the power supply thereby supplying power to the telephonic hub.

18. A method for allowing a user to access a network, the method comprising:
(a) receiving a signal from the network; and
(b) using a router to route the signal to a network access module as claimed in any claim 1, the network access module communicatively coupled with the router.

19. A method as claimed in claim 18 wherein the signal received from the network is an electrical signal, and further comprising converting the electrical signal into an optical signal that is routed to the network access module.
